(19) United States
(12) Patent Application Publication
(10) Pub. No.: US 2010/0091731 A1
(43) Pub. Date: Apr. 15, 2010

(54) CHANNEL ALLOCATION METHOD AND APPARATUS FOR WIRELESS COMMUNICATION NETWORKS

(75) Inventors: Sung Min KIM, Suwon-si (KR); Chul Jin Kim, Yongin-si (KR); Eun Hwa Lee, Suwon-si (KR); Jung Hyeon Kim, Hwaseong-si (KR); Ji Hye Hur, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/578,234

(22) Filed: Oct. 13, 2009

(30) Foreign Application Priority Data
Oct. 13, 2008 (KR) 10-2008-0100312

(51) Int. Cl. H04W 72/04

(52) U.S. Cl. 370/329

(57) ABSTRACT

A channel allocation method for use in a wireless communication environment, where Wireless Local Area Networks (WLANs) and Wireless Personal Area Networks (WPANs) coexist, includes collecting, at an access point, information on channels used by the WLANs and WPANs, determining available WLAN channels and available WPAN channels based on the channel information, allocating one of the available WLAN channels and one of the available WPAN channels to the access point, and informing the WLANs and WPANs of the allocated WLAN and WPAN channels.

### PRIORITY

This application claims priority under 35 U.S.C. 119 to an application entitled “CHANNEL ALLOCATION METHOD AND APPARATUS FOR WIRELESS COMMUNICATION NETWORKS” filed in the Korean Intellectual Property Office on Oct. 13, 2008 and assigned Serial No. 10-2008-0100312, the contents of which are incorporated herein by reference.

### BACKGROUND OF THE INVENTION

1. Field of the Invention

The present invention relates generally to a wireless communication system and, in particular, to a channel allocation method and apparatus for avoiding internetwork interference in a communication environment where heterogeneous wireless communication networks coexist.

2. Description of the Related Art

The 2.4 GHz Industrial, Scientific, and Medical (ISM) band is shared by different wireless communication technologies such as WiFi, Bluetooth®, and ZigBee®, for a Wireless Local Area Network (WLAN) and Wireless Personal Area Network (WPAN).

Such communication technologies are commonly characterized by relative short radio coverage and mobility management capability. Since WLANs and WPANs are complementary rather than competing with each other, many application models have been envisioned for situations requiring WiFi and Bluetooth® and/or ZigBee® to operate simultaneously. Under these conditions, the transmissions can overlap and mutually interfere with each other, which causes severe system throughput degradation.

Currently, when two different technologies interfere with each other, the technology having the stronger transmission energy is likely to achieve successful transmission, while the technology having a weaker energy is likely to experience a severe degradation in system performance.

Accordingly, there is therefore a need of a technique to avoid interference between heterogeneous networks having short radio coverage and supporting mobility such as WPAN and WLAN.

### SUMMARY OF THE INVENTION

In order to overcome the problems of the prior art, the present invention provides a channel allocation method and apparatus that is capable of allocating the frequencies (channels) efficiently without transmission overlap between heterogeneous networks sharing a frequency band.

In accordance with the present invention, a channel allocation method in a wireless communication environment where WLANs and WPANs coexist includes collecting, at an access point, information on channels used by the WLANs and WPANs, checking available WLAN channels and available WPAN channels based on the channel information, allocating one of the available WLAN channels and one of the available WPAN channels to the access point, and informing the WLANs and WPANs of the allocated WLAN and WPAN channels.

In accordance with the present invention, a channel allocation method in a wireless communication environment where WLANs and WPANs coexist includes discovering, at a coordinator, an access point of one of the WLANs, requesting the discovered access point to channel information, and allocating a WPAN channel to as the coordinator's own WPAN channel based on the channel information received from the discovered access point.

In accordance with the present invention, a channel allocation apparatus in a wireless communication environment where WLANs and WPANs coexist includes a WLAN channel processor which communicates using a WLAN channel, a WPAN channel processor which communicates using a WPAN channel and collects information on WLAN and WPAN channels used by the WLANs and WPANs, and a channel negotiator which checks available WLAN and WPAN channels based on the collected channel information, allocates one of the available WLAN channels and one of the available WPAN channels to an access point to which the channel allocation apparatus belongs, and informs the WLANs and WPANs of the allocated WLAN and WPAN channels.

In accordance with the present invention, provided is a channel allocation apparatus in a wireless communication environment where WLANs and WPANs coexist, including a coordinator which discovers an access point of one of the WLANs, requests the discovered access point to channel information, and allocates a WPAN channel as the coordinator's own WPAN channel based on the channel information received from the discovered access point.

### BRIEF DESCRIPTION OF THE DRAWINGS

The above and other objects, features and advantages of the present invention will be more apparent from the following detailed description in conjunction with the accompanying drawings, in which:

FIG. 1 illustrates a wireless communication system to which a channel allocation method according to the present invention is applied;

FIG. 2 illustrates a configuration of an Access Point (AP) according to the present invention;

FIG. 3 illustrates frequency spectrum for WLAN and WPAN in the wireless communication environment to which a channel allocation method according to the present invention is applied;

FIG. 4 illustrates a structure of a channel information table for used in a channel allocation method according to the present invention;

FIG. 5 illustrates a channel allocation method of a WLAN in a heterogeneous wireless communication environment according to the present invention;

FIG. 6 illustrates a channel allocation method of a WPAN in a heterogeneous wireless communication environment according to the present invention;

FIG. 7 illustrates a channel configuration method in a communication environment when a new WPAN is formed in a situation where multiple WPANs exist already according to the present invention;

FIG. 8 illustrates a channel configuration method in a communication environment when a new WPAN is formed in a situation where multiple WPANs exist already according to a first embodiment of the present invention; and

FIGS. 9 and 10 illustrate a channel configuration method in a communication environment when a new WPAN is formed in a situation where multiple WPANs exist already according to a second embodiment of the present invention.

### DETAILED DESCRIPTION OF THE EMBODIMENTS

Embodiments of the present invention are described with reference to the accompanying drawings in detail. The same reference numbers are used throughout the drawings to refer to the same or like parts. Detailed descriptions of well-known functions and structures incorporated herein may be omitted for the sake of clarity and conciseness.

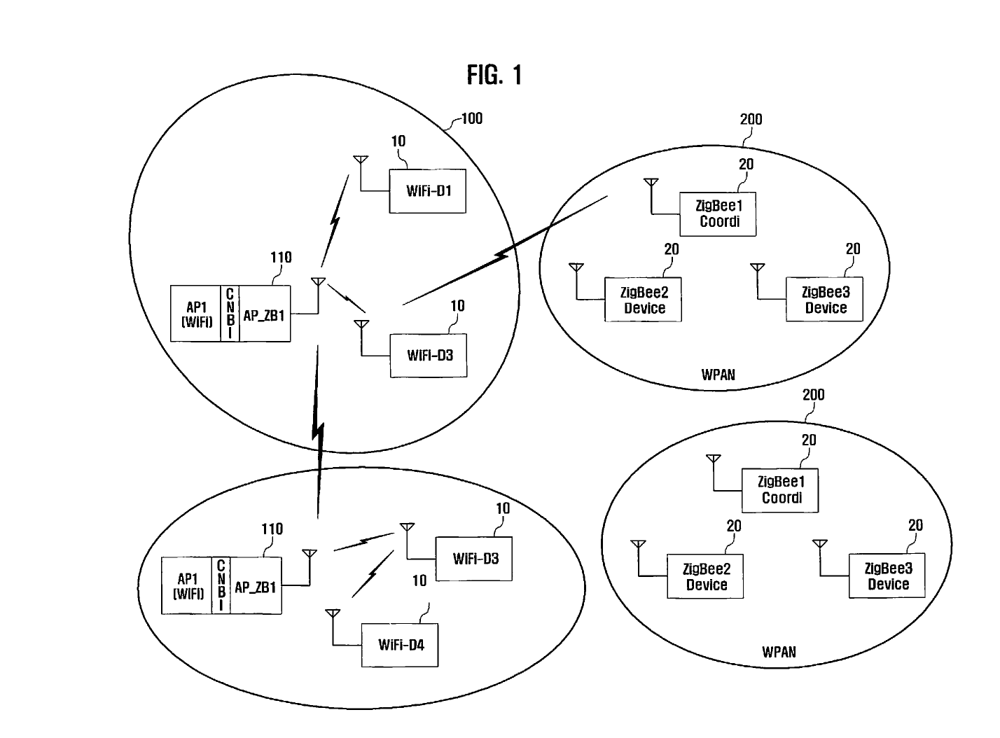

FIG. 1 illustrates a wireless communication system to which a channel allocation method according to the present invention is applied.

Referring to FIG. 1, the wireless communication system corresponding to a heterogeneous network environment includes Wireless Local Area networks (WLANs) 100 and Wireless Personal Area Networks (WPANs) 200.

Each WLAN 100 is a wireless network composed of an Access Point (AP) 110 and WLAN devices 10 served by the AP 110. Each WPAN 200 is another type of wireless network composed of a plurality of WPAN devices 20.

Since the WLANs 100 and WPANs 200 operate in the same frequency band and support mobility, the WLAN and WPAN devices 10 and 20 are likely to be in close proximity to one another and thus the two systems may overlap in the frequency domain. This overlap can cause the WLANs 100 and WPANs 200 to interfere with one another, degrading performance in respective networks.

In the present invention as shown in FIG. 1, the AP 110 of each WLAN 100 collects data about the frequency channels and provides the respective networks the information on the overlap-free channels (available channels) in order to avoid the internetwork interference.

In the following description, the channel allocation method is directed to a heterogeneous network environment in which the WLANs 100 based on WiFi technology and the WPANs 200 based on ZigBee® technology coexist. Accordingly, the WLAN devices 10 are WiFi devices, and the WPAN devices 20 are ZigBee® devices. However, the present invention is not limited to the above environment but can be applied to the wireless communication systems in which different technology-based homogeneous and/or heterogeneous wireless networks coexist.

In the present invention, the WLAN devices 10 are IEEE 802.11b standard based-WiFi devices that are capable of accessing the AP 100. The WLAN devices 10 can include WiFi-enabled mobile devices such as laptop computer and Personal Digital Assistant (PDA) and network cards that can be attached to such mobile devices.

The WPAN 200 is a short-range radio network composed of wireless communication devices in the range of about 10 m. These devices are configured to automatically establish a connection and synchronize with each other to form a WPAN when they are placed within the radio coverage. The WPAN devices 200 are provided with the IEEE 802.15.4 radio interface and MAC layer. These devices can be micro devices using low power and having a small size of about 1 mm.

The devices of the WPAN 200 can be classified into Full Function Devices (FFDs) and Reduced Function Devices (RFDs), and the FFDs can be classified into a Personal Area Network (PAN) coordinator and a coordinator. Unlike the RFDs, the FFDs are implemented with routing functions. Each FFD can be either the PAN coordinator or a coordinator. The PAN coordinator is responsible for managing the WPAN to which it belongs. In the present invention, the coordinator can be a PAN coordinator or just a coordinator.

The AP 110 is coupled to a core network of a wideband mobile communication system and provides packet service to the WLAN devices.

The AP 110 is configured to allocate channels to the WLAN devices 10 without overlapping with the channels allocated to other WLAN and WPAN devices 10 and 20. Particularly, the AP 110 can provide the WPAN devices 20 with the information on the available channels that are not overlapped.

In order to achieve this purpose, the AP 110 collects the channel information of the adjacent WLANs and WPANs 100 and 200 and negotiates with other APs to avoid frequency overlapping. The operations of the AP 110 are described hereinafter in more detail.

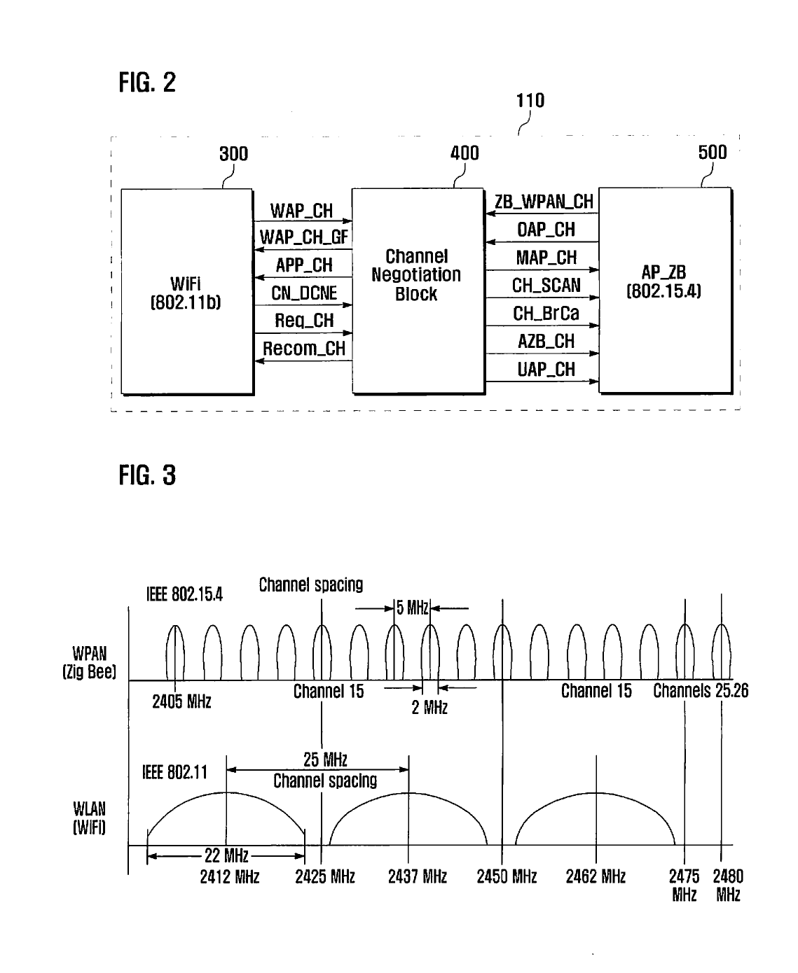

FIG. 2 illustrates a configuration of an AP according to the present invention.

Referring to FIG. 2, the AP 110 includes a WLAN channel processor 300, a Channel Negotiation Block (CNB) 400, and a WPAN channel processor (AP_ZB) 500.

The WPAN channel processor 500 communicates over a WPAN channel. The WPAN channel processor 500 collects channel information on adjacent WLANs 100 and WPANs 200 and provides the channel information to the channel negotiation block 400. For this purpose, the WPAN channel processor 500 can form a single node WPAN including only itself.

When the WPAN 200 is formed by the WPAN channel processor 500, the WPAN channel processor 500 can communicate with the coordinators of the adjacent WPANs to collect channel information. The WPAN channel processor 500 also can communicate with the WPAN channel processors of the APs of other WLANs to collect the channel information of the other WLANs. In this case, the WPAN channel processors of the other APs form respective WPANs.

The channel negotiation block 400 manages the channel information collected by means of the WPAN channel processor 500. The channel negotiation block 400 also can broadcast the channel information periodically by means of the WPAN channel processor 500.

When the channel information is requested by another AP, the channel negotiation block 400 transmits the channel information by means of the WPAN channel processor 500.

When the channel information is received from other WPAN channel processors or coordinators of other WPANs, the WPAN channel processor 500 operates as a normal device of the WPANs. At this time, the WPAN channel processor 500 communicates with the other WPAN processor or the coordinator through the channel used by the other WPAN processor or the coordinator. When it broadcasts or transmits its channel information, the WPAN channel processor 500 is preferably operating as the coordinator of the WPAN. In this manner, the WPAN channel processor 500 forms a single node WPAN to send its channel information.

The channel negotiation block 400 can check the channel used by the WLAN 100 and transmit recommended ZigBee® channel information to the WPAN 200 by means of the WPAN channel processor 500. The recommended ZigBee® channel information indicates a channel minimizing the interference with the channels used by the WLAN 100 so as to reduce the performance degradation of the WPAN 200. The larger the gap between the channels, the less the interference between the channels. The recommended channel is one of the available channels.

In the present invention as shown in FIG. 2, the channel negotiation block 400 selects a channel having the least probability of interference with the currently used WLAN channel among the available channels based on the channel information collected by means of the WPAN channel processor 500 and recommends the selected channel, thereby avoiding interference among the WLANs 100 and WPANs 200. Since the WLANs 100 and WPANs 200 share the channel information, the collocated WLANs and WPANs can use the channel information for allocating the channels to the devices without interference.

The channel negotiation block 400 can request the WPAN channel processor 500 to scan channels (CH_SCAN). If channel scan is requested, the WPAN channel processor 500 scans the channels and transfers the channel information, i.e. the WPAN channel information (ZB_WPAN_CH) and other WLAN channel information (OAP_CH), obtained by channel scanning to the channel negotiation block 400.

The channel negotiation block 400 sends available WLAN channel information (AAP_CH) to the WLAN channel processor 300, and the WLAN channel processor 300 sends wanted channel information (WAP_CH) to the channel negotiation block 400. If the wanted channel information is received, the channel negotiation block 400 sends a confirmation signal (WAP_CH_GF) to the WLAN channel processor 300. Upon receipt of the confirmation signal (WAP_CH_GF), the WLAN channel processor 300 sends a channel negotiation complete signal (CN_DONE) to the channel negotiation block 400 to finish the channel negotiation procedure.

The channel negotiation block 400 informs the WPAN channel processor 500 of the channel (MAP_CH) allocated to the AP 110 of the current WLAN 100 and instructs the WPAN channel processor 500 to notify the other WLANs' APs and WPANs' coordinators of the allocated channel (BH_BrCa).

When it is required to transmit the channel information by means of the WPAN channel processor 500, the channel negotiation block 400 sends the available channel information (AZB_CH) and the currently used channel information (UAP_CH) to the WPAN channel processor 500.

The WLAN channel processor 300 is responsible for connecting the WLAN devices 10 to the core network for providing packet service. The WLAN channel processor 300 queries to the channel negotiation block 400 whether the wanted channel (WAP_CH) is available, and the channel negotiation block 400 can inform the WLAN channel processor 300 whether the wanted channel is available (WAP_CH_GF). Also, the WLAN channel processor 300 can request the channel negotiation block 400 to allocate a channel (Req_CH), and the channel negotiation block 400 informs the WLAN channel processor 300 of a recommend channel (Recom_CH).

FIG. illustrates a frequency spectrum for the WLAN and the WPAN in the wireless communication environment to which a channel allocation method according to the present invention is applied.

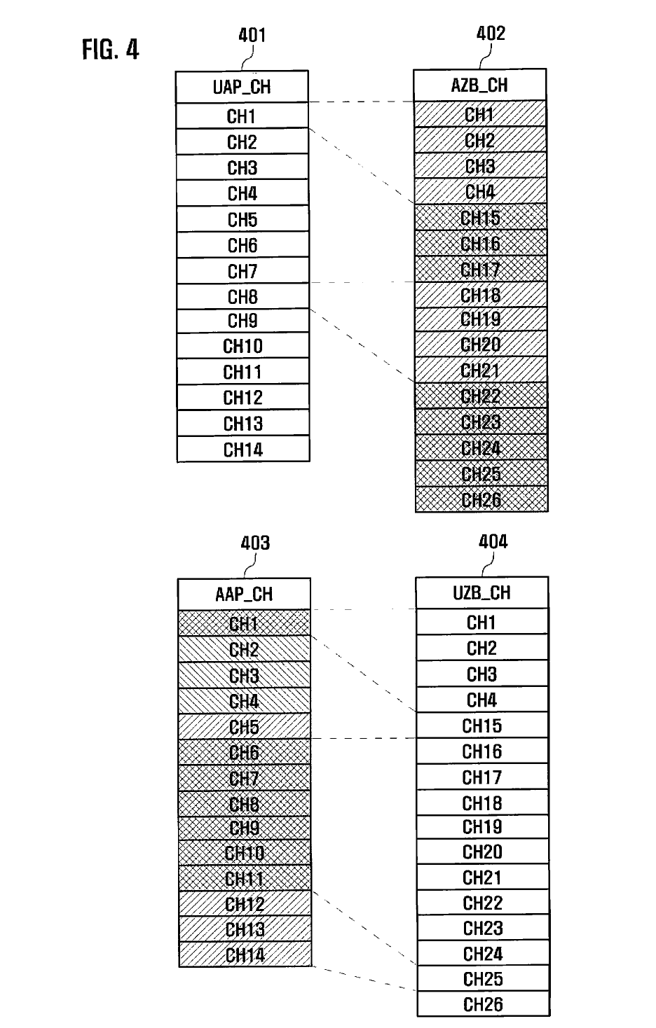

As shown in FIG. 3, the frequency channels of the WLAN 100 and the WPAN 200 overlap. In the case of FIG. 3, the WLAN is a WiFi network composed of WiFi devices, and the WPAN is a ZigBee® network composed of ZigBee® devices.

The ZigBee® standard specifies operation in 868 MHz, 915 MHz, and 2.4 GHz bands, and the raw data rate is 20 Kbps in 868 MHz, 40 Kbps in 915 MHz, and 250 Kbps in 2.4 GHz. FIG. 3 shows the frequency channels of 2.4 GHz band ZigBee®. In the 2.4 GHz band, there are 16 ZigBee® channels, each having a 2 MHz bandwidth, arranged at an interval of 5 MHz.

Meanwhile, the WiFi standards specify operation in the Industrial, Scientific and Medical (ISM) band, and the WLAN 100 is a WiFi network operating in the 2.4 GHz ISM band. There are 14 WiFi channels (CH1 to CH14) designated in the 2.4 GHz range spaced 5 MHz apart. FIG. 3 shows 3 WiFi channels (CH1, CH6, and CH11) that are used in the WLAN 100. The CH1 has the center frequency of 2.412 GHz (2.401 GHz˜2.423), CH6 has the center frequency of 2.437 GHz (2.426 GHz˜2.448 GHz), and CH11 has the center frequency of 2.462 GHz (2.451 GHz˜2.473 GHz).

As shown in FIG. 3, the WiFi-based WLAN 100 and the ZigBee®-based WPAN 200 overlap in frequency domain, and 1 WLAN channel is overlapped with 4 WPAN channels.

In the present invention, a channel information table can be used for managing the frequency channels to avoid channel overlap between the WLAN 100 and WPAN 200. The channel information table is described hereinafter.

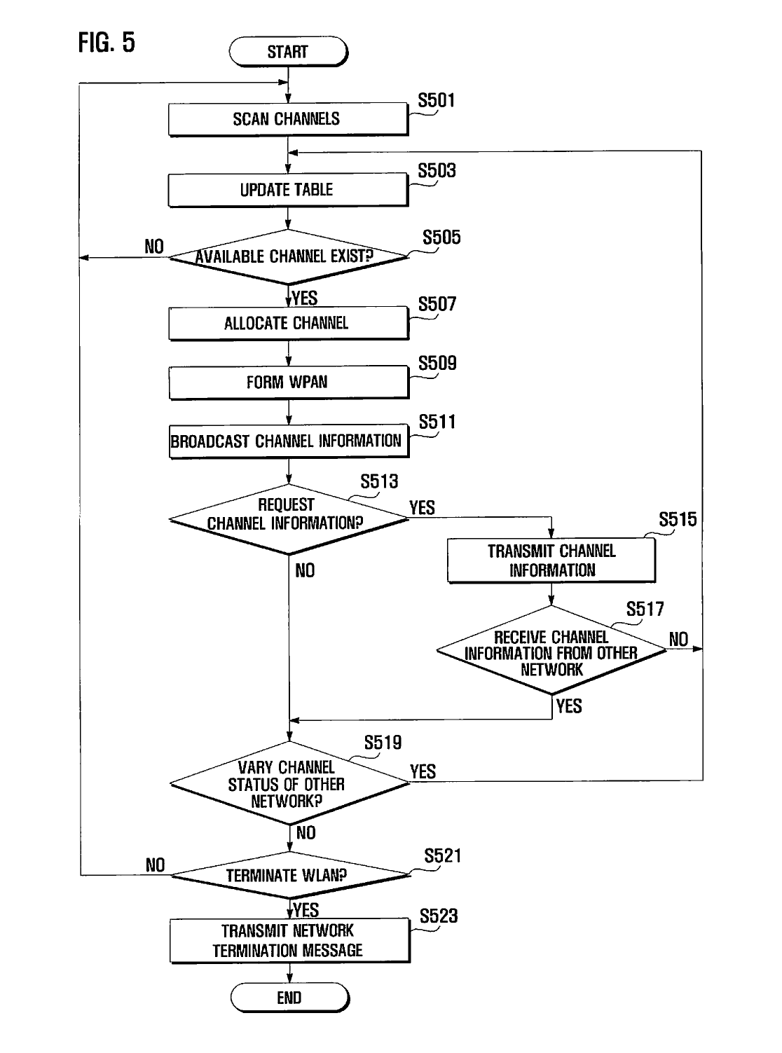

FIG. 4 illustrates a structure of a channel information table for used in a channel allocation method according to the present invention.

As shown in FIG. 4, there are 4 channel information tables. The UAP_CH table 401 is a WLAN channel table listing the WLAN channels that can be used in the WLAN 100, and the AZB_CH table 402 is a WPAN-prohibited channel table indicating the channels that may or may not be used in the WPAN 200 in consideration of the WLAN channels used in the WLAN 100. The UZB_CH table 404 is a WPAN channel table indicating the WPAN channels that can be used in the WPAN 200, and the AAP_CH table 403 is a WLAN-prohibited channel table indicating the channels that may or may not be used in the WLAN 100 in consideration of the WPAN channels used in the WPAN 200.

In FIG. 4, the WLAN channel table 401 is depicted under the assumption that the WLAN 100 is currently using the WLAN channels CH1 and CH8. In this case, the WPAN 200 registers the WPAN channels CH1 to CH4 corresponding to the WLAN channel CH1 and the WPAN channels CH18 to CH22 corresponding to the WLAN channel CH8 as the WPAN-prohibited channels with the WPAN-prohibited channel table 401 and registers the remaining WPAN channels as the available WPAN channels with the WPAN-prohibited channel table 401. This indicates that the WPAN channels CH15 to CH17 and CH22 to CH26 are available for the WPAN 200.

In FIG. 4, the WPAN channel table 404 is depicted under the assumption that the WPAN 200 is currently using the WPAN channels CH15 and CH25. In this case, the WLAN 100 registers the WLAN channels CH2 to CH5 corresponding to the WPAN channel CH15 and the WLAN channels CH12 to CH14 corresponding to the WPAN channel CH25 as the WLAN-prohibited channels with the WLAN-prohibited channel table 403 and registers the rest WLAN channels as available WLAN channels with the WLAN-prohibited channel table 403. This indicates that the WPAN channels CH1 to CH4, CH16 to CH16 to CH24, and CH26 are available for the WPAN 200.

In this manner, the prohibited WPAN channels and the used WPAN channels can be checked. If the prohibited WPAN channels and the used WPAN channels are excluded, then non-prohibited and non-used channels remain as available channels.

From the viewpoint of the WLAN 100, since the WLAN channels CH1 and CH8 are used already and the WLAN channels CH2 to CH5 and CH12 to CH14 are prohibited from use, the WLAN 100 has the available WLAN channels of CH6, CH7, and CH9 to CH11. From the viewpoint of the WLAN 200, since the WPAN channels CH1 to CH4 and CH18 to CH21 are prohibited and the WPAN channels CH15 and CH25 are used already, the WPAN 200 has the available WPAN channels of CH16, CH17, CH22 to CH24, and CH26.

If a new WLAN 10 is deployed within the radio coverage of the WLAN 100 (hereinafter old WLAN) while the WLAN channels CH1 and CH2 are allocated by the WLAN 100 already and the WPAN channels CH15 and CH25 are allocated by the WPAN 200 already as shown in FIG. 4, the old WLAN 100 sends the channel information (table) to the AP 110 of the new WLAN 100 for guiding the new WLAN 100 to use the available WLAN channels (i.e. the WLAN channels of CH6, CH7, and CH9 to CH11). Also, the old WLAN 100 can request the AP 110 of the new WLAN 100 to use the WLAN channel CH7 or CH9, to maximize the number of remained available channels in consideration of the used WPAN channels.

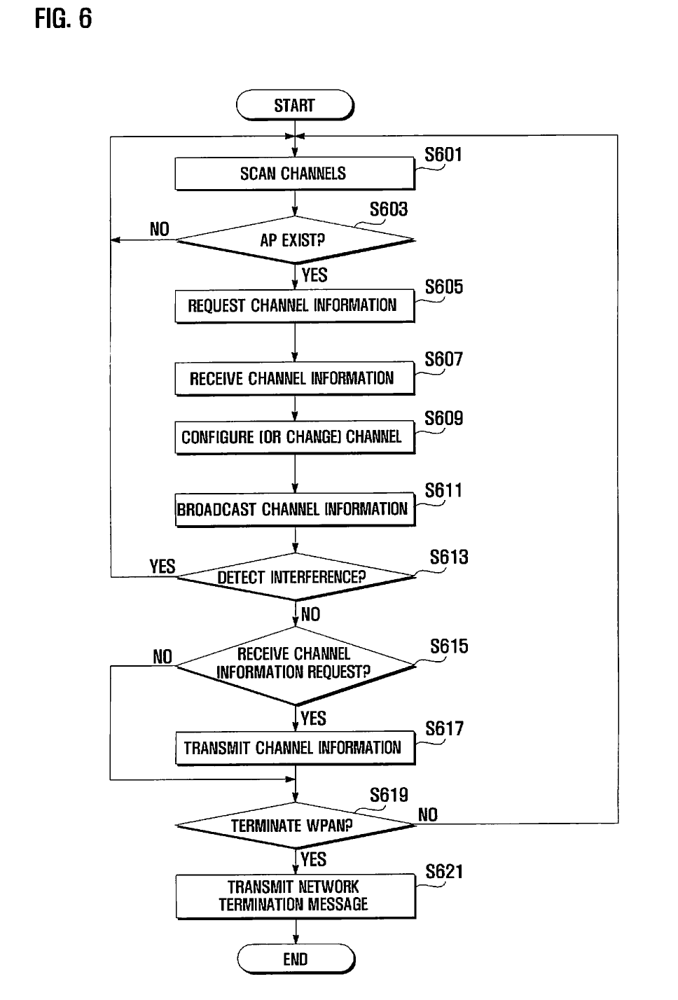

FIG. 5 illustrates a channel allocation method of a WLAN in a heterogeneous wireless communication environment according to the present invention.

Referring to FIG. 5, once a WLAN AP 110 switches on or a periodic channel scanning time has elapsed, the WLAN AP 110 scans the channels to search for the WPAN coordinators and other WLAN APs by means of the WPAN channel processor 500 (S501). That is, the WLAN AP 110 controls the WPAN channel processor 500 to scan the WPAN channels and WLAN channels. After completing the channel scanning process, the WLAN AP 110 updates the channel information table (S503).

Once the channel information table is successfully updated, the WLAN AP 110 determines whether an available WLAN channel exists by referencing the updated channel information table (S505). If no available WLAN channel exists, the procedure returns to step 501 to repeat the channel scanning. Otherwise, if at least one available WLAN channel exists, the WLAN AP 110 allocates one of the at least one available WLAN channel to itself (S507).

At this time, the WLAN AP 110 determines whether a user's preferred channel exists among the at least one available WLAN channel. If the user's preferred channel exists among the at least one available WLAN channel, the WLAN AP 110 configures the WLAN with the user's preferred channel. If the user's preferred channel does not exists among the at least one available WLAN channel, the WLAN AP 110 can configure the WLAN with one of the at least one available WLAN channel or a WLAN channel that is already used by an adjacent WLAN 100. Since the WLAN AP 110 performs the channel scanning and updates the channel information table periodically, it is preferred to determine the existence of the user's preferred channel among the available WLAN channels whenever the channel information table is updated.

After allocating an available WLAN channel to itself, the WLAN AP 110 allocates a WPAN channel to the WPAN channel processor 500 to form a single node WPAN 200 (S509). Next, the WLAN AP 110 broadcasts its channel information (S511). At this time, the WPAN channel processor 500 of the WLAN AP 110 broadcasts the channel information within the single node WPAN.

After allocating the WLAN channel to it, the WLAN AP 110 operates on the allocated WLAN channel and determines whether a channel information request is received from other networks including WLANs and WPANs (S513). The channel information can be requested by an AP of another WLAN or a coordinator of another WPAN.

If a channel information request is received, the WLAN AP 110 transmits the channel information to the network that requests the channel information (S515). At this time, the WLAN AP 110 can transmit at least one of the WLAN channel table 401, WPAN-prohibited channel table 402, WLAN-prohibited channel table 403, WPAN channel table 404, available channels based on the channel information tables, and a recommended channel based on the channel information tables.

Also, the WLAN AP 110 can regard the receipt of the channel information request as a formation of a new network and thus wait for receiving the channel information of the new network. Accordingly, after transmitting the channel information at step S515, the WLAN AP 110 determines whether channel information is received from the new network (S517). If channel information is received from the new network, the procedure returns to step S503 to update the channel information table.

Returning to step S513, if no channel information request is received in a predetermined time, the WLAN AP 110 determines whether there is a variation of channel status in other networks (S519). The variation of channel status in other networks is detected by receiving the channel information triggered by creation and extinction of other WPAN or WLAN. If there is a variation of channel status in other networks, the procedure returns to step S503 to update the channel information table. In this manner, the WLAN AP 110 updates the channel information periodically.

If there is no variation of channel status in other networks at step S519, the WLAN AP 110 determines whether a network termination request for terminating the WLAN 100 to which it belongs is detected (S521). If a network termination request is detected, the WLAN AP 110 transmits a network termination message indicating the release of its channel to adjacent WLAN APs (S523) and then terminates the network. If no network termination request is detected, the procedure returns to step S501 to repeat channel scanning.

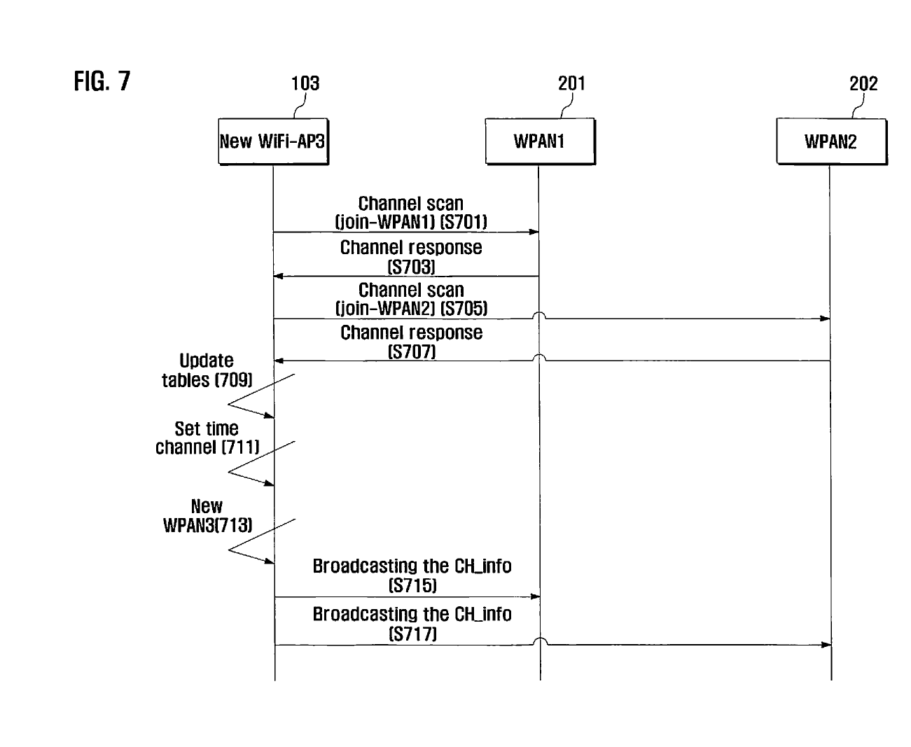

FIG. 6 illustrates a channel allocation method of a WPAN in a heterogeneous wireless communication environment according to the present invention.

In FIG. 6, the channel configuration is performed by a node of the WPAN 200. It is preferred that the node is a coordinator of the WPAN.

Referring to FIG. 6, when a new WPAN 200 is formed, the WPAN 200 scans the WLAN and WPAN channels to search for adjacent WLANs and WPANs (S601). While performing the channel scan, the WPAN 200 determines whether a WLAN AP is discovered (S603). The discovery of a WPAN channel processor can be regarded as the existence of a WLAN AP. More than one AP can be discovered. If at least one WLAN is discovered, the WPAN 200 requests the WLAN to send the channel information (S605) and receives the channel information from the WLAN AP 110 (S607). After receiving the channel information from the WLAN AP 110, the WPAN 200 configures (or changes) its channel (S609). When the channel information is received from more than one AP, the WPAN 200 configures the channel in consideration of all the received channel information. The WPAN 200 broadcasts the channel information to advertise its channel (S611).

Next, the WPAN 200 communicates over the configured channel and determines whether interference is detected (S613). If an error occurs or the channel condition parameters such as Receiver Signal Strength Indicator (RSSI) and Clear Channel Assessment (CCA) are poor, the WPAN 200 determines that channel interference is detected. If channel interference is detected, the procedure returns to step S601 such that the WPAN 200 repeats steps S601 to S609.

If no interference is detected, the WPAN 200 determines whether a channel information request is received from another network (S615). If a channel information request is received from another network, the WPAN 200 sends its channel information to the network requested the channel information (S617).

Next, the WPAN 200 determines whether a WPAN termination request is detected (S619). If a WPAN termination request is not detected in a predetermined time, the procedure returns to step S601. Otherwise, if a WPAN termination request is detected, the WPAN 200 sends the network termination message containing its channel information to adjacent networks (S621) and terminates the network.

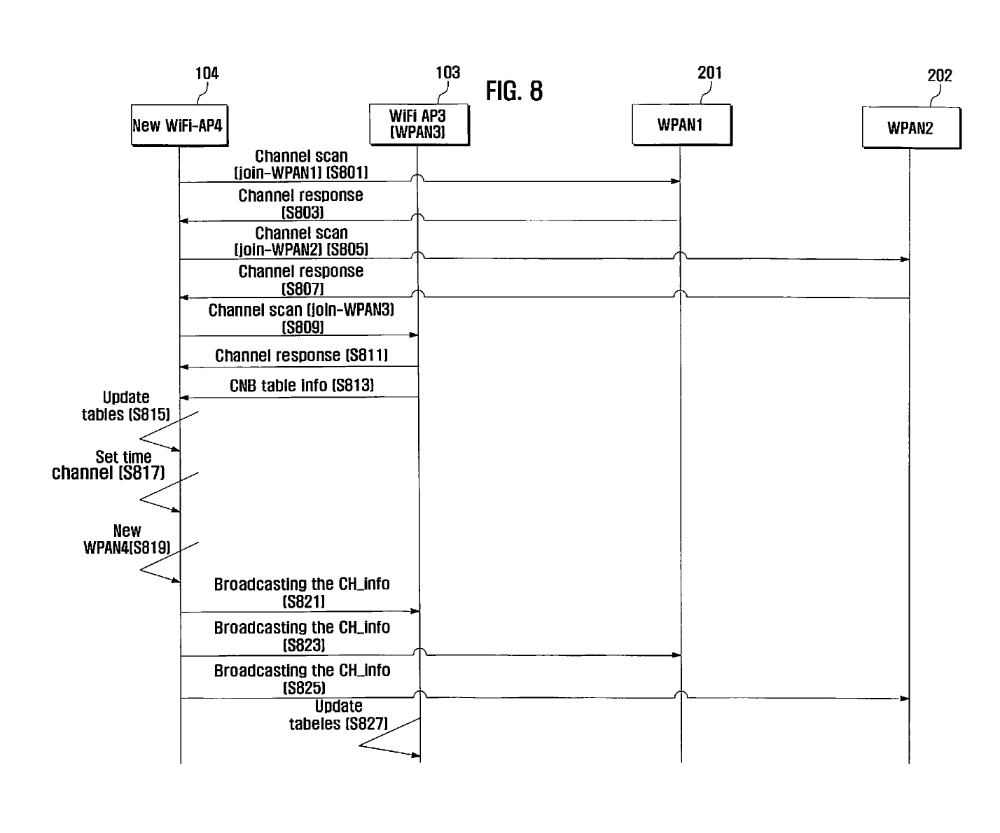

FIG. 7 illustrates a channel configuration method in a communication environment when a new WPAN is formed in a situation where multiple WPANs exist already according to the present invention.

FIG. 7 is depicted under the assumption that a WLAN AP forms a new WPAN in a situation where the WPAN1 201 and WPAN2 202 are operating. That is, the AP3 103 switches on in an area where the WPAN1 201 and WPAN2 202 are already deployed.

Referring to FIG. 7, once the AP3 103 is switched on, it scans WLAN and WPAN channels and finds the networks (including WLANs and WPANs) that are currently operating, i.e. WPAN1 201 and WPAN2 202. At this time, the AP3 103 can join each of the WPAN1 201 and WPAN2 202 as a node of the respective WPANs 201 and 202 to acquire channel information.

That is, the AP3 103 joins the WPAN1 201 as a WPAN device by means of the WPAN channel processor 500 (S701) and receives the channel information from the WPAN1 201 (S703). Also, the AP3 103 joins the WPAN2 202 as a WPAN device by means of the WPAN channel processor 500 (S705) and receives the channel information from the WPAN2 202 (S707).

After acquiring the channel information from the WPAN1 201 and the WPAN2 202, the AP3 103 updates its channel information table (S709). Next, the AP3 103 selects one of available channels by referencing the updated channel information table as its own channel and sets time channels (S711). The AP3 103 configures a WPAN channel to form a new WPAN, i.e. WPAN3 103 (S713). The WPAN3 103 is a single node WPAN including the WPAN channel processor 500 of the AP3 103 as a WPAN device. By forming the WPAN3, the AP3 103 can communicate with the WPAN1 201 and WPAN2 202. After forming the WPAN3, the AP3 103 broadcasts its channel information (S715 and S717).

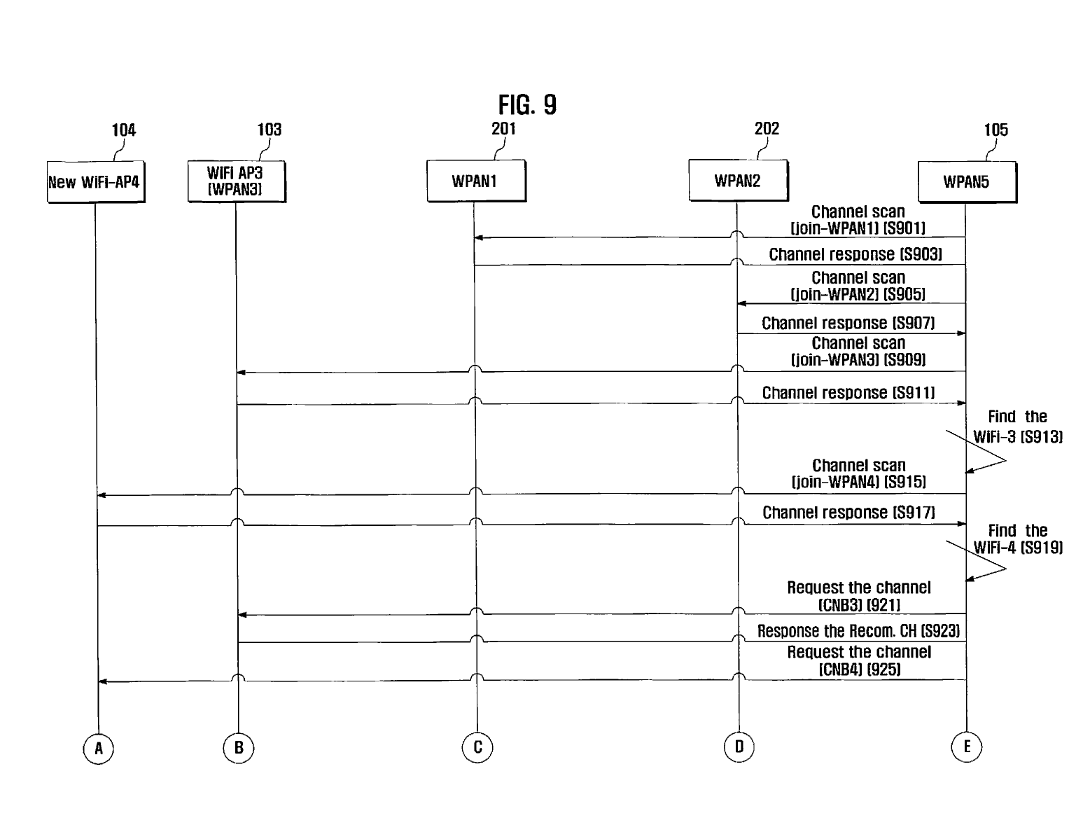

FIG. 8 illustrates a channel configuration method in a communication environment when a new WPAN is formed in a situation where multiple WPANs exist already according to a first embodiment of the present invention.

FIG. 8 is depicted under the assumption that a WLAN AP forms a WPAN in a situation where the WPAN1 201, WPAN2 202, and WPAN3 103 are operating. That is, the AP4 104 switches on in an area where the WPAN1 201, WPAN2 202, and WPAN3 103 are already deployed.

Referring to FIG. 8, once the AP4 104 is switched on, it scans WLAN and WPAN channels and finds the adjacent networks (including WLANs and WPANs) that are currently operating, i.e. WPAN1 201, WPAN2 202, and WPAN 103. At this time, the AP4 105 can join each of the WPAN1 201, WPAN2 202, and WPAN3 130 as a node of the respective WPANs 201, 202, and 103 to acquire channel information.

That is, the AP4 104 joins the WPAN1 201 as a WPAN device by means of the WPAN channel processor 500 (S801) and receives the channel information from the WPAN1 201 (S803). The AP4 104 joins the WPAN2 202 as a WPAN device by means of the WPAN channel processor 500 (S805) and receives the channel information from the WPAN2 202 (S807). The AP4 joins the WPAN3 103 as a WPAN device by means of the WPAN channel processor 500 (S809) and receives the channel information from the WPAN3 103 (S811). Particularly, the AP3 (i.e. the WPAN3) transmits its channel information table to the AP 104 (S813).

After acquiring the channel information from the WPAN1 201, WPAN2 202, and WPAN3 103, the AP4 104 updates its channel information table (S815). The AP4 104 selects one of available channels by referencing the updated channel information table as its own channel and sets time channels (S817). The AP4 104 configures a WPAN channel to form a new WPAN, i.e. WPAN4 104 (S819). The WPAN4 104 is a single node WPAN including the WPAN channel processor 500 of the AP4 104 as a WPAN device.

After forming the WPAN4, the AP4 104 broadcasts its channel information (S821, S823, and S825). Upon receipt of the channel information broadcast by the AP4 104, the AP3 103 updates its channel information table (S817).

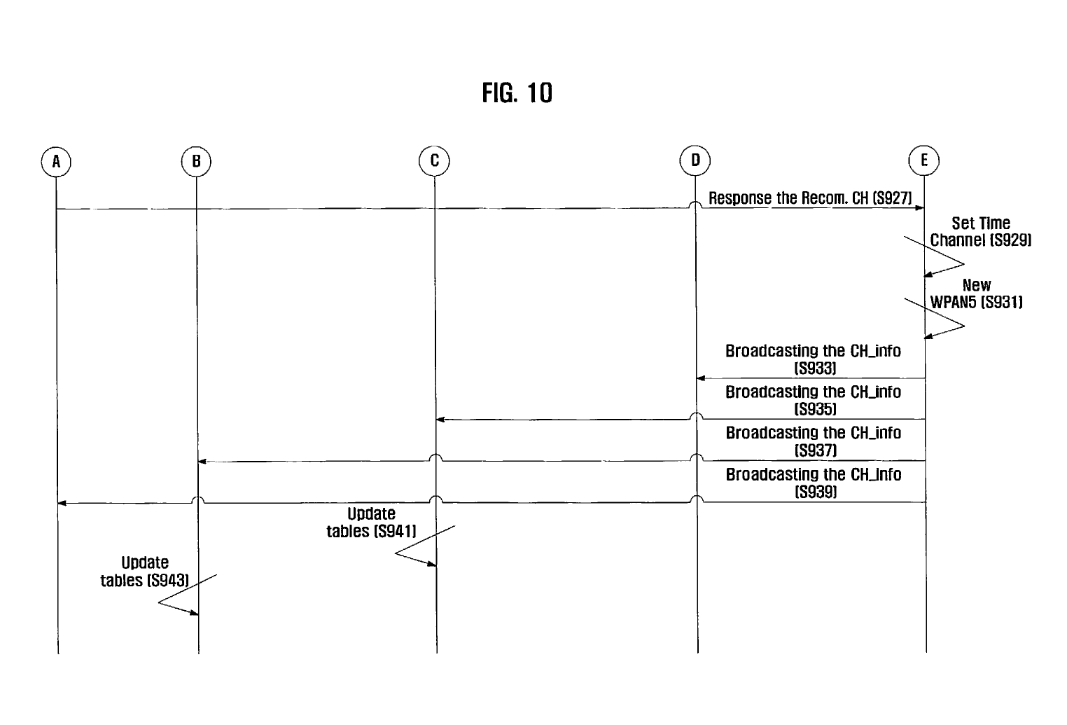

FIGS. 9 and 10 illustrate a channel configuration method in a communication environment when a new WPAN is formed in a situation where multiple WPANs exist already according to a second embodiment of the present invention.

FIGS. 9 and 10 are depicted under the assumption that a WLAN AP forms a WPAN in a situation whether the WPAN1 201, WPAN2 202, WPAN3 103, and WPAN4 104 are operating. That is, the AP5 105 switches on in an area where the WPAN1 201, WPAN2 202, WPAN3 103, and WPAN4 104 are already deployed.

Referring to FIGS. 9 and 10, once the AP5 105 is switched on, it scans WLAN and WPAN channels and finds the adjacent networks (including WLANs and WPANs) that are currently operating, i.e. WPAN1 201, WPAN2 202, WPAN3 103, and WPAN4 104. At this time, the AP 5 can join each of the WPAN1 201, WPAN2 202, WPAN3 103, and WPAN4 104 as a node of the respective WPANs 201, 202, 103, and 104 to acquire channel information.

That is, the AP5 105 joins the WPAN1 201 as a WPAN device by means of the WPAN channel processor 500 (S901) and receives the channel information from the WPAN1 201 (S903). The AP5 105 joins the WPAN2 202 as a WPAN device by means of the WPAN channel processor 500 (S905) and receives the channel information from the WPAN2 202 (S907).

The WPAN5 105 joins the WPAN3 103 as a WPAN device by means of the WPAN channel processor 500 (S909) and receives the channel information from the WPAN3 103 (S911). Upon receipt of the channel information from the WPAN3 103, the WPAN5 105 finds the WLAN AP3 103 (S913). The WPAN5 105 joins the WPAN4 104 as a WPAN device by means of the WPAN channel processor 500 (S915) and receives the channel information from the WPAN4 104 (S917). Upon receipt of the channel information from the WPAN4 104, the WPAN5 105 finds the WLAN AP4 104 (S919).

If the WLAN APs, i.e. AP3 103 and AP4 104, are found, the WPAN 105 requests the WLANs (AP3 103 and AP4 104) to send the channel information. That is, the WPAN 205 requests the AP3 103 and AP4 104 for their channel information (S921 and 925) and receives the channel information from the AP3 103 and AP4 104 (S923 and S927).

After acquiring the channel information related to the WPAN and WLAN channels from the WPAN1 201, WPAN2 202, WPAN3 103, and WPAN4 104, the WPAN5 105 selects one of available channels by referencing the channel information acquired from all the adjacent WPANs (S929) and configures a WPAN channel to form a new WPAN, i.e. WPAN5 105 (S931). After forming the WPAN5, the AP 105 broadcasts its channel information (S933, S935, S937, and S939).

Upon receipt of the channel information broadcast by the AP5 105, the AP3 103 and AP4 104 update their channel information table (S941 and S943).

As described above, the channel allocation method and apparatus of the present invention collects information on the channels used by adjacent networks including homogeneous and heterogeneous networks, and shares the available information channel information acquired based on the collected channel information with the adjacent networks, thereby avoiding internetwork interference.

Although embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A channel allocation method in a wireless communication environment where Wireless Local Area Networks (WLANs) and Wireless Personal Area Networks (WPANs) coexist, comprising:
collecting, at an access point, information on channels used by the WLANs and WPANs;
determining available WLAN channels and available WPAN channels based on the channel information;
allocating one of the available WLAN channels and one of the available WPAN channels to the access point; and
informing the WLANs and WPANs of the allocated WLAN and WPAN channels.

2. The channel allocation method of claim 1, further comprising providing, when a new network is formed and requests channel information, the new network with at least one of entire WLAN and WPAN channels information, available WLAN and WPAN channels information, and recommended WLAN and WPAN channels information.

3. A channel allocation method in a wireless communication environment where Wireless Local Area Networks (WLANs) and Wireless Personal Area Networks (WPANs) coexist, comprising:
discovering, at a coordinator, an access point of one of the WLANs;
requesting the discovered access point to channel information; and
allocating a WPAN channel to as the coordinator's own WPAN channel based on the channel information received from the discovered access point.

4. The channel allocation method of claim 3, further comprising:
re-requesting, when interference is detected on the allocated WPAN channel, the discovered access point for the channel information again; and
updating the allocated WPAN channel based on the channel information received again from the discovered access point.

5. A channel allocation apparatus in a wireless communication environment where Wireless Local Area Networks (WLANs) and Wireless Personal Area Networks (WPANs) coexist, comprising:
a WLAN channel processor which communicates using a WLAN channel;
a WPAN channel processor which communicates using a WPAN channel and collects information on WLAN and WPAN channels used by the WLANs and WPANs; and
a channel negotiator which determines available WLAN and WPAN channels based on the collected channel information, allocates one of the available WLAN channels and one of the available WPAN channels to an access point to which the channel allocation apparatus belongs, and informs the WLANs and WPANs of the allocated WLAN and WPAN channels.

6. The channel allocation apparatus of claim 5, wherein the channel negotiator provides, when a new network is formed and requests channel information, the new network with at least one of entire WLAN and WPAN channels information, available WLAN and WPAN channels information, and recommended WLAN and WPAN channels information.

7. A channel allocation apparatus in a wireless communication environment where Wireless Local Area Networks (WLANs) and Wireless Personal Area Networks (WPANs) coexist, comprising a coordinator which discovers an access point of one of the WLANs, requests the discovered access point to channel information, and is allocates a WPAN channel as the coordinator's own WPAN channel based on the channel information received from the discovered access point.

8. The channel allocation apparatus of claim 7, wherein the coordinator re-requests, when interference is detected on the allocated WPAN channel, the discovered access point for the channel information again and updates the allocated WPAN channel based on the channel information received again from the discovered access point.
